(19) United States
(12) Patent Application Publication
(10) Pub. No.: US 2016/0063887 A1
(43) Pub. Date: Mar. 3, 2016

(54) LEARNING SYSTEM FOR MEDICAL CODING

(71) Applicant: Ariana Petritaj, Tallahassee, FL (US)

(72) Inventor: Ariana Petritaj, Tallahassee, FL (US)

(21) Appl. No.: 14/473,022

(22) Filed: Aug. 29, 2014

(51) Int. Cl. G09B 19/00

(52) U.S. Cl. CPC G09B 19/00

(57) ABSTRACT

A learning system for medical coding comprising: analyzing patient history before examination; charting the patient history on a historical component table; providing a summary of the patient history; determining an examination component of coding; tabulating data reviewed; determining risk complications and managing a course of action based on the data. The patient history includes: a chief complaint, a history of present illness, review of the patient's various systems and post-family or social history. The examination component may include the organ system and body area of a patient. Further, the course of action includes three elements, numbering of diagnosis and management options, amount and complexity of data reviewed, risk of complication and morbidity or mortality. Any tabulated data includes pathology, radiology and complex test results.

### BACKGROUND OF THE INVENTION

1. Field of Invention

The present invention relates to a system and method to educate and learn medical coding systems.

2. Description of Related Art

Medical field includes a classification or coding system that provides codes for medical diagnoses and medical procedures. Further coding is also related to pharmaceutical and topographical coding, where topographical coding is related to particular locations of a patient's body. The medical coding system provides universal medical coding numbers that are associated with particular diseases and health conditions. The procedural codes coincide with the actual procedures that are performed based upon the associated diagnosis. This coding system is used throughout the medical field and applied in public health facilities, government health programs, health insurance providers, workers' compensation providers and other aspects of the medical health administration. Many medical professionals are required to learn such “coding” in order to provide accurate and adequate records of medical procedures and diagnoses performed. Typical coding is learned through a training process that sometimes can be time consuming and difficult for students. Subsequently it would be advantageous to have a system and a supporting software that can help in the teaching and learning of medical coding systems.

### SUMMARY OF THE INVENTION

The present invention relates to a learning system for medical coding comprising of:

Determining the individual levels of service for each key component:

History, Examination, and Medical Decision-Making from the documentation. We analyze the three key components-history, examination, and medical decision-making. We figure out what level of service is documented for each key component. Each key component has its own unique set of service levels.

First we have to figure out what level of service is performed for the history component. We analyze the patient history before the examination, charting the patient history on a historical component table, providing a summary of the patient history.

There are four levels of service for the history component.
The four levels are:
Problem focused, Expanded problem focused, Detailed, Comprehensive.
Each level of service has certain requirements.
The history component consists of four elements:

1. Chief complaint (CC)

2. History of present illness (HPI)

3. Review of systems (ROS)

4. Past, family, and/or social history (PFSH)

We then analyze each element CC, HPI, ROS, PFSH based on the patients chart and the levels of service is also included in the chart. Under each table there are specific rules to help choose and to find the final level. We then circle the elements we find in the scenario. After that we compile all of information from the previous tables and put them in the summary tables to determine the overall history component.

The lowest of all components determines the level of service for the history component. The chart help to figure out which history elements are required to each history level of service. It also shows how much information must be included for an element to qualify for a specific level of service.

The second key component for the Evaluation and management level of service is: The Examination Component. We have to figure out what level of service is performed for the examination component. As with the History Component, there are four levels of service for the examination component.

The four levels are:

1. Problem focused

2. Expanded problem focused

3. Detailed

4. Comprehensive

Each levels of service have certain requirements.
The Examination Component consist of two elements:

1. Organ System (OS)

2. Body Areas (BA)

We analyze the information of the patient according to the list of Organ and Body Areas. After we circle how many elements we find in the Examination Component table. The levels of service are also included in the chart. The charts are designed to help you determine the accurate level of service for the Examination Component.

The third (final) key component is: Medical Decision-Making. The Medical Decision Making has four levels of service.

The four levels are:

1. Straightforward

2. Low Complexity

3. Moderate Complexity

4. High Complexity

Each level of service has certain requirements. The Medical Decision-Making consists of the three elements:

1. Number of Diagnoses and Management Option.

2. Amount and/or Complexity of Data Reviewed

3. Risk of complication and/or Morbidity or Mortality

We figure out what level of service is performed for the Medical Decision-Making. We determine the level of service for each element of the Medical Decision-Making based on the patient's chart. The levels of service are also included in the chart. Each table help to choose and find the final level. We then circle the elements we found in the scenario. After that we compile all of the information from previous tables and put them in the summary table to determine the overall medical decision making.

After that the lowest level is crossed out and then pick the next highest. Lowest level is crossed out and then pick the next Highest is the determination of the overall level of Medical Decision Making.

### DETAILED DESCRIPTION

The present invention relates to a medical coding system-in particular a system that enables a user to learn medical coding. The present system provides a user a system to learn diagnostic and procedural coding. The diagnostic and procedural coding is associated with two stages.

Stage one with an evaluation and management procedure related to the place of the services, types of services and the patient's status.

The second stage relates to the determining the individual levels of service for each key component: history, examination, and medical decision-making.

We figure out what level of service is documented for each key component. For example, a level of service for the history component will tell you how extensively the medical history is documented. A level of service for the Medical Decision Making Component will tell you the complexity of the decision.

Each key component has its own unique set of service levels.

### First Key Component

First we have to figure out what level of service is performed for the History Component. Patients are evaluated initially to determine their history before examination. The patient history is associated with a particular coding that implemented by the medical professional.

The history component has four levels of service.
The four levels are:

1. Problem Focused

2. Expanded Problem Focused

3. Detailed

4. Comprehensive

Each level of service has certain requirements. These requirements incorporate not only what history elements were included in an E/M procedure, but to what degree.
For example, was there a brief or extended history taken for the present illness or problem?
The history component analysis relates essentially to four elements:

1. Chief Complaint (CC)

2. History of Present Illness (HPI)

3. Review of Systems (ROS)

4. Past, Family, and/or Social History (PFSH)

We analyze each element: CC, HPI, ROS, PFSH based on the patient's chart.

The levels of serve are also included in the chart.

The present invention uses history component tables as shown below to analyze each particular element based upon the patient's chart. The chart help to figure out which history elements are required for each history level of service. It also shows how much information must be included for an element to qualify for a specific level of service. For example, for detailed level of service for the history component, the HPI must be Extended. For an Expanded Problem Focused level of service for the history component, the HPI only needs to brief. To determine the level of history, we will use the following table:

History Component Table

| Check | Key Components | Required |
|---|---|---|
| | CC | |
| | Describe the symptom, problem, | |
| | or condition that is the reason | |
| | for this encounter: | |
| | HPI | Number of |
| | Location? | Characteristics: |
| | Quality? | 1-3 = Brief |
| | Severity? | 4 or more extended |
| | AS&S | |
| | Timing? | |
| | Duration? | |
| | Context? | |
| | Modifying Factors? | |
| | ROS | Number of Systems: |
| | Constitutional? | 1 = Problem Pertinent |
| | Eyes? | 2-9 = Extended |
| | Ears, Nose, Mouth, Throat? | 10 or more Complete |
| | Cardiovascular? | |
| | Respiratory? | |
| | Gastrointestinal? | |
| | Genitourinary? | |
| | Musculoskeletal? | |
| | Integumentary? | |
| | Neurological? | |
| | Psychiatric? | |
| | Endocrine? | |
| | Hematologic/Lymphatic? | |
| | Allergic/Immunologic? | |
| | PFSH | Number of Elements: |
| | Past History | 1 of 3 = Pertinent |
| | Past Medical history | 2 of 3 = Complete |
| | Illness/injury | |
| | Current medications | |
| | Past operations | |
| | No allergies (you can count) | |
| | Family History | |
| | Medical events in patients family | |
| | Health status of family | |
| | Family Diseases | |
| | Social History | |
| | Marital Status | |
| | Employment | |
| | Level of education | |
| | Sexual history | |
| | Drugs | |
| | Alcohol | |
| | Tobacco | |
| | Denies alcohol use (can count) | |

We analyze each element CC, HPI, ROS, PFSH based on the patient's chart. Under each table there are specific rules to help choose and to find the final level. We then circle the elements we find in the scenario.

1) CC (Chief Complaint

| | Problem | Expanded | | |
|---|---|---|---|---|
| History | Focused | Problem | Detailed | Comprehension |
| CC | required | required | required | required |

We circle the highest documented level.

2) HIP (History of Present Illness)

| | Problem | Expanded | | |
|---|---|---|---|---|
| History | Focused | Problem | Detailed | Comprehension |
| HPI | Brief | Brief | Extended 4 | Extended 4 |
| | 1 to 3 | 1 to 3 | | |

The goal is to code to the highest level documented.

3) ROS (Review of System)

| | Problem | Expanded | | |
|---|---|---|---|---|
| History | Focused | Problem | Detailed | Comprehension |
| ROS | N/A | Pertinent | Extended | Complete |
| | | 1 system | 2 to 9 | 10 |

We circle how many elements we find in the list of systems based on the scenario.

4) PFSH (Post Family and or Social History)

| | Problem | Expanded | | |
|---|---|---|---|---|
| History | Focused | Problem | Detailed | Comprehension |
| PFSH | N/A | N/A | Pertinent | Complete |
| | | | 1 of 3 | 2 of 3 |

We circle how many elements we find in the scenario.

The chart provides a scenario where specific rules are applied to each particular area of the history. Various areas of history may require analysis of a small number of characteristics based upon the patient's condition. The analysis of the history is compiled and provided in a summary of history table as shown below.

SUMMARY HISTORY TABLE

| | Problem | Expanded | | |
|---|---|---|---|---|
| History | Focused | Problem | Detailed | Comprehension |
| CC | required | required | required | required |
| HPI | Brief | Brief | Extended 4 | Extended 4 |
| | 1 to 3 | 1 to 3 | | |
| ROS | N/A | Pertinent | Extended | Complete |
| | | 1 system | 2 to 9 | 10 |
| PFSH | N/A | N/A | Pertinent | Complete |
| | | | 1 of 3 | 2 of 3 |

### Level of Service for the History Component

The lowest of all components determines the level of service for the history component. This complies all of information from the previous tables and puts them in the summary tables to determine the overall history component.
The chief compliant and history of the present illness provide the highest level of documentation. Then a review of the system and post-family or social history is provided in detail based upon the number of systems involved. The level of service may be expanded based upon the problem encountered.
The second key component for the Evaluation and Management level of service is:

### The Examination Component.

This is the description of the findings from the physician's examination of the patient. The History Component was subjective, or fiction. The examination component is objective, based on factual date the physician has determined. We have to figure out what level of service is performed for the examination component. As with the History Component, there are four levels of service for the examination component.
The four levels are:

1. Problem focused

2. Expanded problem focused

3. Detailed

4. Comprehensive

Each level of service has certain requirements.
The Examination Component consist of two elements:

1. Organ System (OS)

2. Body Areas (BA)

We analyze the information of the patient according to the list of Organ and Body Areas. Only one item in each OS/BA needs to be documented. After, we circle how many elements we find in the Examination Component table. The levels of services are also included in the chart. The charts are designed to help you determine the accurate level of service for the Examination Component. The present invention uses a examination table as show below to analyze each particular element based upon the patient's chart. The charts help to figure out which examination element are required for each examination level of service. The examination component provides an organized approach for patient analysis to be used in accordance with medical coding. The determination of the examination component tables therefore helps to identify the components of examination as needed.

Examination Component Table

| | | |
|---|---|---|
| Check | Organ Systems | Number of Organ |
| | Constitutional? | Systems |
| | Eyes? | |
| | Ears, Nose, Mouth, Throat? | |
| | Cardiovascular? | |
| | Respiratory? | |
| | Gastrointestinal? | |
| | Genitourinary? | |
| | Skin? | |
| | Musculoskeletal? | |
| | Neurological? | |
| | Psychiatric? | |
| | Hematologic/Lymphatic/Immunologic? | |
| | Body Areas | Number of Body |
| | Head, Face? | Areas Documented |
| | Neck? | |
| | Chest, Breast, Axilla? | |
| | Abdomen? | |
| | Genitalia, Groin, Buttock? | |
| | Back, Spine? | |
| | Each Extremity? | |

After that we compile all of information from the previous table and put them in the summary tables to determine the overall Examination Component. The level of service for the Examination Component determine based upon the number of systems involved. For instance, the level of service for Examination Component is: Expanded Problem based upon the (2-4OS/BA) elements we find in the examination table component from the patient's chart.

Summary Examination Table

| | Problem | Expanded | | |
|---|---|---|---|---|
| Exam | Focused | Problem | Detailed | Comprehension |
| | 1 OS/BA | 2-4 OS/BA | 5-7 OS/BA | 8 OS |

### Level of Service for the Examination Component

The Third (final) key component of Medical Coding is: Medical Decision Making. The Medical Decision Making has four levels of service.

The four levels are:

1. Straightforward

2. Low Complexity

3. Moderate Complexity

4. High Complexity

Each level of service has certain requirements.

The Medical Decision-Making consists of the three elements:

1. Number of Diagnoses and Management Option.

2. Amount and/or Complexity of Data Reviewed

3. Risk of complication and/or Morbidity or Mortality
We need to figure out what level of service is performed for the Medical Decision-Making. We determine the level of service for each element of the Medical Decision-Making based on the patient's chart. The levels of service are also included in the chart. Each table helps to choose and find the final level.

We then circle the elements we found in the scenario. After that we compile all of the information from the previous tables and put them in the summary table to determine the overall medical decision-making. After that, the lowest level is crossed out and one must pick the next highest level to determine the overall level of Medical Decision Making.

1. Number of Diagnoses and Management Options.

This element of Medical Decision-Making relates in particular to the problem and diagnoses/plan of action. To determine the level of service for this element we analyze the problem and the plan of action. The Diagnosis and Management table presents a number of problems and plan of action. We use this table that is designed to help for determine the final level of service for decision making for this element. We will analyze the information of the patient according to this table and after we will circle the level we found on the Diagnosis and Management table on the other management table.

For example: the decision making becomes extensive based upon additional work-up planned of the patient. As shown the self-limited or minor problems becomes minimal decision making based upon plan of action (stable, improving, worsening) of the patient analysis. If the level is Minimal after we have analyzed the information of the patient according to the Diagnosis and Management table. Number of diagnosis and management option has four levels:

1. Minimal

2. Limited

3. Multiple

4. Extensive

We use the table that is designed to help to determine the level of service for decision making for this element.

Diagnosis Management Options Table

| | | Decision | |
|---|---|---|---|
| Problem | Diagnosis/Plan of Action | Making | Check |
| Self-limited or minor | Stable, improving, | Minimal | |
| | worsening | | |
| Established w/ Doctor | Stable, improved | Minimal | |
| Established w/ Doctor | Worsening | Limited | |
| New to Doctor | No additional work-up | Multiple | |
| | planned | | |
| New to Doctor | Additional work-up planned | Extensive | |

Patient information is analyzed according to this table and the level may be indicated we found on the Diagnosis and Management table on the other management table. See below

| | | Low | Moderate | High |
|---|---|---|---|---|
| MDM | Straightforward | Complexity | Complexity | Complexity |
| Dx/Mgmt | minimal | limited | multiple | Extensive |

2. Amount and/or Complexity of Data Reviewed is:

The second element of the MDM (Medical Decision Making) component involves counting what is documented. Documenting the results of a lab test counts toward reviewing date for pathology. We use the table (Amount and/or Complexity of Data Reviewed) that depicts specific information to help determine the level service for decision making for this element. If you look at this table the patient may require data from pathology, radiology, complex test results and further may require an examination of old medical records or addition history. The total score determines the level of decision making for this element.

The levels of service for this element are four:

0 to 1-Minimal or None

2-Limited

3-Moderate

4 of more-Extensive

We will analyze the information of the patient according to this table and after we will circle the level we found on the date reviewed table, on the other management table.
Amount and/or Complexity of Data Reviewed

To determine the level of this service we will use the following table:

Data Reviewed Table

| Check | Score | Data Reviewed |
|---|---|---|
| | (1) | Pathology & Laboratory: One or more tests |
| | (1) | Radiology: One or more tests |
| | (1) | Other Diagnostics Studies: One or more studies or |
| | | services |
| | (2) | in CPT 90701-99199 |
| | | Complex test results: Direct visualization, independent |
| | | interpretation of specimen, image or tracing previously |
| | (1) | interpreted by another MD. Each test is counted |
| | | separately. |
| | (2) | Old records or additional history: Evaluating need for or |
| | | decision to obtain. |
| | Total | Summarizing review/obtaining additional history from |
| | Score | family, caretaker, or other source. |
| | 0 to 1 | Level of Service for Amount and/or Complexity of Data |
| | 2 | Reviewed |
| | 3 | |
| | 4 | Minimal or None |
| | or | Limited |
| | more | Moderate |
| | | Extensive |

The total score determines the level of decision making for this element.

As shown the charts are designed to help you determine the accurate level of service for the amount and/or complexity of data review. The amount and/or complexity of the data review therefore creates a scale related to the final determination of coding associated with this diagnostic procedure.

| | | Low | Moderate | High |
|---|---|---|---|---|
| MDM | Straightforward | Complexity | Complexity | Complexity |
| Data | Min/none | limited | moderate | extensive |

The score we found in the table above this one we circle the level on this table.

3. Risk of Complication and/or Morbidity or Mortality is:

The third element of Medical Decision Making. For determining the level of service for this element, we use the table of risk that is designed for this process. If you read through the table the level of risk at the far left column.

There are four levels of service:

1. Minimal

2. Low

3. Moderate

4. High

The type of risk is categorized by:

The presenting problem, the diagnostic procedure(s) ordered, and by the management options selected. This element of decision-making is determined by the highest level of risk in any one category. The Minimal Risk due to one self-limited or minor problem, requires laboratory test and also needs rest, gargles, etc. The High Risk has one or more chronic illnesses, which requires cardiovascular imaging studies and also needs emergency major surgery.

Between minimal risk and high risk are different management options selected and also diagnostic procedure(s) ordered. The Moderate has one or more chronic illnesses with mild exacerbation and requires diagnostic endoscopy with no identified risk factors and also needs minor surgery with identified risk factors. The low risk has two or more self-limited or minor problem, requires superficial needle biopsies and also needs minor surgery with no risk factors. To determine the level of service for this element we use this table. We will analyze the information of the patient according to the table of risk and after we will circle the level we found on the table of risk, on the other management table.

3. Risk of Complications and/or Morbidity or Mortality

To determine the level of service for this element we will use the following table:

Table of Risk

| | | | Diagnostic | |
|---|---|---|---|---|
| | | Presenting | Procedure(s) | Management |
| Check | Level of Risk | Problem(s) | Ordered | Options Selected |
| | Minimal | One self-limited or | Laboratory tests | Rest, gargles; |
| | | minor problem | requiring | elastic bandage |
| | | | venipuncture; chest | superficial |
| | | | x-ray; EKG/EEG; | dressing |
| | | | urinalysis; | |
| | | | ultrasound | |
| | Low | Two or more self- | Superficial needle | Over-the-counter |
| | | limited or minor | biopsies, clinical lab | drugs; minor |
| | | problems; one | tests with arterial | surgery w/no risk |
| | | stable, well- | puncture, | factors; IV fluids |
| | | controlled chronic | physiological tests | w/o additives; |
| | | illness; acute | not under stress, | physical or |
| | | uncomplicated | non-cardiovascular | occupational |
| | | illness or injury | imaging studies with | therapy |
| | | | contrast | |
| | Moderate | One or more | Diagnostic | Minor surgery |
| | | chronic illnesses | endoscopies with no | w/identified risk |
| | | with mild | identified risk | factors; |
| | | exacerbation; two | factors; obtain fluid | prescription drug |
| | | or more stable | form body cavity | management; IV |
| | | chronic illnesses; | (lumbar puncture, | fluids with |
| | | undiagnosed new | thoracentesis) | additives; closed |
| | | problem | | treatment of |
| | | w/uncertain | | fracture or |
| | | prognosis; acute | | dislocation w/o |
| | | complicated injury | | manipulation |
| | High | One or more | Cardiovascular | Emergency major |
| | | chronic illness | imaging studies; | surgery, |
| | | w/server | cardiac | parenteral |
| | | exacerbation; | electrophysiological | controlled |
| | | acute or chronic | tests; diagnostic | substances; drug |
| | | illness or injuries | endoscopes; | therapy requiring |
| | | that pose threat to | discography | intensive |
| | | life or bodily | | monitoring; |
| | | function; abrupt | | decision not to |
| | | change in | | resuscitate due to |
| | | neurological | | poor prognosis; |
| | | status. | | elective major |
| | | | | surgery |
| | | | | w/identified risk |
| | | | | factors |

The determined level according to the table above will be circled in the following table:

| | | Low | Moderate | High |
|---|---|---|---|---|
| MDM | Straightforward | Complexity | Complexity | Complexity |
| Risk | Minimal | Low | Moderate | high |

After the risk complications have been assessed and a determined level has been provided each element of the medical decision-making is compiled in a summary decision-making table.

Summary MDM Tabe

| | | Low | Moderate | High |
|---|---|---|---|---|
| MDM | Straightforward | Complexity | Complexity | Complexity |
| Dx/Mgmt | Minimal | Limited | Multiple | extensive |
| Data | Min/none | limited | moderate | extensive |
| Risk | minimal | low | moderate | high |

After we determine each element of medical decision making we compile the information in a Summary Decision Making Table and circle the elements found. After that the lowest level is crossed out and then pick the next highest. For example, here, the Data element is the lowest. We cross that out and determine the overall level of service with the remaining two. The level is Moderate Complexity.

Summary MDM Table

| | | Low | Moderate | High |
|---|---|---|---|---|
| MDM | Straightforward | Complexity | Complexity | Complexity |
| Dx/Mgmt | Minimal | Limited | Multiple | extensive |
| Data | Min/none | limited | moderate | extensive |
| Risk | minimal | low | moderate | high |

Lower levels may be crossed out and there may be a determination that moderate complex medical decision may be accompanied with the particular procedure. This will enable the coder to then identify codes that are appropriate for each of the procedures that are in these particular areas of medical service. By using this particular system to implement medical coding an individual may easily learn and acquire knowledge of codes associated with the various levels of determination after application of the above procedures. Going through this process allows an individual to grasp a better understanding of the medical coding system and to address medical codes as applied in practice.

To accurately code the Evaluation and Management service, it is important to follow the steps with the particular procedure. For Evaluation and Management codes, the coder must take into consideration a number of different things.

When coding E/M Evaluation and Management codes, you need to consider:
Where the service was provided?
What type of service was provided?
What was the patient's status?
How much of a medical history was taken?
How much of a medical examination was performed?
How complex of a medical decision was made?
That's a lot of information to keep in mind! This will enable the coder to then identify codes that are appropriate for each of the procedures that are in these particular areas of medical service. By using this particular system to implement medical coding, an individual may easily learn and acquire knowledge of codes associated with the various levels of determination after the application of the procedures above. Going through this process allows an individual to grasp a better understanding of the medical coding system and to address medical codes as applied in practice.

What is claimed is:

1. A learning system for medical coding comprising:
a. analyzing patient history before examination;
b. charting the patient history on a historical component table;
c. providing a summary of the patient history;
d. determining an examination component of coding;
e. tabulating data reviewed;
f. determining risk complications and
g. managing a course of action based on the data.

2. The learning system for medical coding according to claim 1, where the patient history includes: a chief complaint, a history of present illness, review of the patient's various systems and post-family or social history.

3. The learning system for medical coding according to claim 1, where the examination component includes the organ system and body area of a patient.

4. The learning system for medical coding according to claim 1, where the course of action includes three elements, numbering of diagnosis and management options, amount and complexity of data reviewed, risk of complication and morbidity or mortality.

5. The learning system according to claim 1, where the tabulated data includes pathology, radiology and complex test results.

6. The learning system according to claim 1 where the risk complications include four levels; minimal, low, moderate and high.

7. The learning system according to claim 6, where the risk complications include four respective levels of management options: straightforward; low complexity; moderate complexity and high complexity.
